(19) United States
(12) Patent Application Publication
(10) Pub. No.: US 2016/0318454 A1
(43) Pub. Date: Nov. 3, 2016

(54) DRIVING RECORDING DEVICE AND A REGULATION AND CONTROL METHOD USING THE SAME

(71) Applicant: Leauto Intelligent Technology (BEIJING) Co., Ltd., Beijing (CN)

(72) Inventor: Guoqing LIU, Beijing (CN)

(21) Appl. No.: 14/960,320

(22) Filed: Dec. 4, 2015

(30) Foreign Application Priority Data
Apr. 30, 2015 (CN) 20151021478.9

(51) Int. Cl. B60R 11/00; G01P 15/00; G01C 19/00; G07C 5/08

(52) U.S. Cl. CPC B60R 11/00; G07C 5/0841; G01P 15/00; G01C 19/00; B60R 2011/0084; B60R 2011/0085; B60R 2011/0092

(57) ABSTRACT

Disclosed are driving recording device and regulation and control method using the same. The device includes a driving recorder and a regulating member. The recorder includes a processor, a gyroscope and an acceleration sensor. The processor sends control instruction to regulating member according to received three-dimensional angular information from gyroscope and three-dimensional acceleration information from acceleration sensor, to control it to perform position regulation and to lead position regulation of recorder such that recorder is in initial status and balanced. The gyroscope, the acceleration sensor and the regulating member are in communication connection with the processor, respectively, and the recorder is connected to regulating member and connected to a vehicle thereby. In the case the vehicle vibrates or quakes, the regulating member performs position regulation and to lead position regulation of recorder, ensuring the recorder is always kept in initial status and balanced to obtain stable and superior travelling records.

### TECHNICAL FIELD

The embodiments of the present invention relate to the field of vehicle safety technologies, and in particular to a driving recording device and a regulation and control method using the same.

### BACKGROUND

With the improvement of people's living standards, vehicles are more and more used in people's lives. The possibility of traffic accidents goes up with increased vehicles travelling on the roads. A complex evidence-gathering problem will be confronted after the occurrence of the traffic accident. In this regard, a driving recorder becomes one of important basis in the evidence-gathering process after the occurrence of the traffic accident.

The so-called driving recorder is an apparatus (also known as a “Black Box” of a vehicle) that records correlative information such as vision and sound when an automobile travels. The driving recorder can capture images through its lens to record vision and sound of a travelling vehicle after being mounted on the vehicle, so as to provide evidences for the traffic accident. As a matter of course, the driving recorder may be used to monitor when the vehicle does not travel.

In the prior art, the driving recorder is usually adhered to the vehicle by adhesive or adsorbed to the vehicle by a strong sucking disc. In practice, however, the vehicle being travelling is inclined to vibrate or quake due to upward and downward bumping, leftward and rightward offsetting or colliding with another vehicle. In the circumstances, the lens of the driving recorder may vibrate or quake to affect the effect of the captured images, or even ghost images may occur in a serious case to make the captured images blurry.

Therefore, how to address drawbacks in the aforesaid existing driving recorder has become a problem to be solved at present.

### SUMMARY

An Embodiment of the present invention provide a driving recording device and a regulation and control method using the same to overcome the drawbacks in the aforesaid driving recorder, ensuring that the driving recorder is always in the initial status and balanced to obtain stable and superior travelling records.

There is provided a driving recording device in the embodiment of the present disclosure, including a driving recorder provided with a processor, the driving recorder further including:

a gyroscope, configured to collect three-dimensional angular information of the driving recorder and send the collected three-dimensional angular information to the processor; and

an acceleration sensor, configured to collect three-dimensional acceleration information of the driving recorder and send the collected three-dimensional acceleration information to the processor;

the driving recording device further including:

a regulating member, configured to perform a position regulation according to a received control instruction from the processor and to lead a position regulation of the driving recorder such that the driving recorder is regulated to an initial status and balanced;

the processor is configured to send the control instruction to the regulating member according to the received three-dimensional angular information from the gyroscope and the received three-dimensional acceleration information from the acceleration sensor, in order to control the regulating member to perform the position regulation and to lead the position regulation of the driving recorder such that the driving recorder is regulated to the initial status and balanced;

wherein, the gyroscope, the acceleration sensor and the regulating member are in communication connection with the processor, respectively, and the driving recorder is connected to the regulating member and connected to a vehicle via the regulating member.

Further, the regulating member is a tri-axial supporting structure including a first shaft, a second shaft and a third shaft which are positioned in three dimensional directions, respectively; the first shaft is a shaft that is arranged in a horizontal direction, perpendicularly connected to the second shaft and movable in a circumferential direction and movable in a circumferential direction on the basis of the second shaft, the second shaft is a shaft that is arranged in a perpendicular direction to the horizontal direction and movable in the perpendicular direction with respect to the first shaft, and the third shaft is a shaft that is perpendicularly connected to the first shaft via a connecting member and forward-backward movable with respect to the second shaft,

wherein, the regulating member receives the control instruction from the processor by the first axis, the second shaft and the third shaft to perform the position regulation.

Further, each of the first shaft, the second shaft and the third shaft is provided with a traction motor,

wherein the first axis, the second shaft and the third shaft receive the control instruction in a form of pulse width modulation signal from the processor the respective traction motors therein.

Further, the traction motor is a brushless DC motor rotatable both in forward and reversal directions.

Further, the gyroscope is a MPU-6050 model gyroscope, and the acceleration sensor is a MMA8452QR1 model acceleration sensor.

There is provided a regulation and control method using a driving recording device in the embodiment of the present disclosure, the driving recording device including a driving recorder provided with a processor, wherein the driving recorder further includes a gyroscope and an acceleration sensor, the driving recording device further includes a regulating member, the gyroscope, the acceleration sensor and the regulating member are in communication connection with the processor, respectively, and the driving recorder is connected to the regulating member and connected to a vehicle via the regulating member;

the method includes:

the processor receiving three-dimensional angular information and three-dimensional acceleration information of the driving recorder collected and sent by the gyroscope and the acceleration sensor, respectively; and

the processor sending a control instruction to the regulating member according to the received three-dimensional angular information and the received three-dimensional acceleration information, in order to control the regulating member to perform a position regulation and to lead a position regulation of the driving recorder such that the driving recorder is regulated to the initial status and balanced.

Further, the step of sending a control instruction to the regulating member according to the received three-dimensional angular information and the received three-dimensional acceleration information, in order to control the regulating member to perform a position regulation and to lead a position regulation of the driving recorder, includes:

filtering noise data from the received three-dimensional angular information and the received three-dimensional acceleration information, to obtain valid three-dimensional angular information and valid three-dimensional acceleration information, respectively; and

sending an angle regulation instruction to the regulating member according to the valid three-dimensional angular information, such that the regulating member performs a correlative angle regulation according to the angle regulation instruction in order to lead the driving recorder to be regulated to the initial three-dimensional angle, and sending an acceleration regulation instruction to the regulating member according to the valid three-dimensional acceleration information such that the regulating member applies correlative reversal acceleration to the driving recorder according to the acceleration regulation instruction.

Further, the three-dimensional angular information contains X-axis angle value, Y-axis angle value, Z-axis angle value;

the step of filtering noise data from the received three-dimensional angular information to obtain valid three-dimensional angular information, includes:

invoking a preset interface for filtering the noise data to real-time obtain X-axis angle value, Y-axis angle value and Z-axis angle value within a predefined period of time, and calculating respective average values of the obtained X-axis angle values, Y-axis angle values and Z-axis angle values;

calculating differences between the X-axis angle values and the average value of X-axis angle values, differences between the Y-axis angle values and the average value of Y-axis angle values and differences between the Z-axis angle values and the average value of Z-axis angle values, to obtain first difference values, second difference values and third difference values; and

comparing the first difference values, second difference values and third difference values with a first predefined X-axis angular threshold a first predefined Y-axis angular threshold and a first predefined Z-axis angular threshold, respectively, and on the ground of the comparison result, filtering the noise data to obtain valid X-axis angle values, Y-axis angle values and Z-axis angle values.

Further, the three-dimensional acceleration information contains X-axis acceleration value, Y-axis acceleration value, Z-axis acceleration value;

the step of filtering the noise data from the three-dimensional acceleration information to obtain the valid three-dimensional acceleration information, includes:

invoking the preset interface for filtering the noise data to real-time obtain X-axis acceleration value, Y-axis acceleration value, Z-axis acceleration value within a predefined period of time, and calculating respective average values of the obtained X-axis acceleration values, Y-axis acceleration values and Z-axis acceleration values;

calculating differences between the X-axis acceleration values and the average value of X-axis acceleration values, differences between the Y-axis acceleration values and the average value of Y-axis acceleration values and differences between the Z-axis acceleration values and the average value of Z-axis acceleration values, to obtain fourth difference values, fifth difference values, sixth difference values; and

comparing the fourth difference values, the fifth difference value and the sixth difference values with a first predefined X-axis acceleration threshold, a first predefined Y-axis acceleration threshold and a first predefined Z-axis acceleration threshold, respectively, and on the ground of the comparison result, filtering the noise data to obtain the valid X-axis acceleration values, Y-axis acceleration values, Z-axis acceleration values.

Further, the method further includes: receiving the three-dimensional angular information of the driving recorder collected and sent by the gyroscope, which contains initial X-axis angle value, initial Y-axis angle value, initial Z-axis angle value of the driving recorder in the initial status;

the step of sending an angle regulation instruction to the regulating member according to the valid three-dimensional angular information, such that the regulating member performs a correlative angle regulation according to the angle regulation instruction in order to lead the driving recorder to be regulated to the initial three-dimensional angle, includes:

calculating an absolute value of a difference between the average value of X-axis angle values and the initial X-axis angle value, an absolute value of a difference between the average value of Y-axis angle values and the initial Y-axis angle value and an absolute value of a difference between the average value of Z-axis angle values and the initial Z-axis angle value, to obtain a first absolute value, a second absolute value and a third absolute value, respectively; and

comparing the first absolute value, the second absolute value and the third absolute value with a second predefined X-axis angular threshold, a second predefined Y-axis angular threshold and a second predefined Z-axis angular threshold, respectively, and on the ground of the comparison result, sending the angle regulation instruction to the regulating member such that the regulating member performs the correlative angle regulation according to the angle regulation instruction in order to lead the driving recorder to be regulated to the initial three-dimensional angle.

Further, the step of sending an acceleration regulation instruction to the regulating member according to the valid three-dimensional acceleration information such that the regulating member applies correlative reversal acceleration to the driving recorder according to the acceleration regulation instruction, includes:

comparing the average value of X-axis acceleration value, the average value of Y-axis acceleration value and the average value of Z-axis acceleration value with a second predefined X-axis acceleration threshold, a second predefined Y-axis acceleration threshold and a second predefined Z-axis acceleration threshold, respectively, and on the ground of the comparison result, sending the acceleration regulation instruction to regulating member such that the regulating member generates the correlative reversal acceleration according to the acceleration regulation instruction.

According to the driving recording device and the regulation and control method using the same in the embodiments of the present disclosure, the driving recording device is provided with the driving recorder and the regulating member; the driving recorder is provided with the processor, the gyroscope and the acceleration sensor; the gyroscope, the acceleration sensor and the regulating member is in communication connection with the processor, respectively; and the driving recorder is connected to the regulating member and connected to the vehicle via the regulating member. Based on this, in the case that the vehicle vibrates or quakes in turn to cause the driving recorder to vibrate or quake, the processor can send the control instructions to the regulating member according to the received three-dimensional angular information from the gyroscope and the received three-dimensional acceleration information from the acceleration sensor, in order to control the regulating member to perform the position regulation and in turn to lead the position regulation of the driving recorder such that the driving recorder can be regulated to the initial status and balanced, ensuring that the driving recorder is always kept in a stabilized status to obtain stable and superior travelling records.

### BRIEF DESCRIPTION OF THE DRAWINGS

In order to more apparently describe the technical schemes in the embodiments of the present disclosure or in the prior art, accompanying figures necessarily used in the description of the embodiments or the prior art will be simply explained hereinafter. Obviously, the accompanying figures described below will form the embodiments of the present disclosure. An ordinary person skilled in the an may conceive further figures in accordance with these accompanying figures without contributing creative labor.

FIG. 1 is a structural schematic diagram of a driving recording device according to an embodiment of the present disclosure;

FIG. 2 is a structural schematic diagram of a regulating member in the driving recording device according to the embodiment of the present disclosure; and

FIG. 3 is a schematic flow chart of a regulation and control method using the driving recording device according to an embodiment of the present disclosure.

### DETAILED DESCRIPTION

In order that objectives, technical schemes and advantages of the embodiments of the present disclosure become more apparent, the technical schemes in the embodiments of the present disclosure will be thoroughly and completely described below in conjunction with the accompanying figures in the embodiments of the present disclosure. It is obvious that the embodiments described herein are some of embodiments of the present disclosure rather than entire embodiments. On the basis of the embodiments of the present disclosure, other embodiments conceived by an ordinary person skilled in the art without creative labor would all fall into the scope of the present invention.

With reference to FIG. 1, it is a structural schematic diagram of a driving recording device according to an embodiment of the present disclosure.

In the embodiment, the driving recording device may include a driving recorder 1 and a regulating member 2; the driving recorder 1 may include a processor 11, a gyroscope 12 and an acceleration sensor 13; the gyroscope 12 and the acceleration sensor 13 can be operated on the basis of a standard three-dimensional coordinate system; the gyroscope 12, the acceleration sensor 13 and the regulating member 2 are in communication connection with the processor 11, respectively; the driving recorder 1 is connected to the regulating member 2 (for example, in a screwing manner); and the driving recorder 1 is connectable to a vehicle via the regulating member 2, wherein

the gyroscope 12, which can be selected from gyroscopes used in existing mobile phones (for example, a MPU-6050 model gyroscope), is configured to collect three-dimensional angular information of the driving recorder 1 and send the collected three-dimensional angular information to the processor 11.

Herein, the three-dimensional angular information of the driving recorder may include: an angle value by which the driving recorder deviates from X-axis (hereinafter referred to as X-axis angle value), an angle value by which the driving recorder deviates from Y-axis (hereinafter referred to as Y-axis angle value), and an angle value by which the driving recorder deviates from Z-axis (hereinafter referred to as Z-axis angle value).

The acceleration sensor 13, which can be selected from acceleration sensors used in existing mobile phones (for example, a MMA8452QR1 model acceleration sensor), is configured to collect three-dimensional acceleration information of the driving recorder 1 and send the collected three-dimensional acceleration information to the processor 11.

Herein, the three-dimensional acceleration information of the driving recorder may include: an acceleration value of the driving recorder on X-axis (hereinafter referred to as X-axis acceleration value), an acceleration value of the driving recorder on Y-axis (hereinafter referred to as Y-axis acceleration value), and an acceleration value of the driving recorder on Z-axis (hereinafter referred to as Z-axis acceleration value).

The processor 11 is configured to send a control instruction to the regulating member 2 according to the received three-dimensional angular information from the gyroscope 12 and the received three-dimensional acceleration information from the acceleration sensor 13, in order to control the regulating member 2 to perform a position regulation and in turn to lead a position regulation of the driving recorder 1 such that the driving recorder 1 is regulated to the initial status and balanced.

The initial status may include three-dimensional angle in the initial status and three-dimensional acceleration in the initial status. For example, after the driving recording device is mounted on the vehicle (that is, after the driving recorder is fixed to the vehicle by the regulating member), the driving recorder may be manually regulated to an appropriate position (information relation to the vehicle, such as forward vision of the travelling or parked vehicle, sounds inside the vehicle and the like, can be clearly captured; for example, the driving recorder can be regulated such that its lens is in a relatively horizontal position), and then the gyroscope can capture the correlative three-dimensional angular information of the driving recorder in this status. The three-dimensional angular information in this status is regarded as the three-dimensional angle in the initial status.

The driving recorder is regulated to the initial status, which means that the three-dimensional angle of the driving recorder is regulated to the three-dimensional angle in the initial status.

The regulating member 2 is configured to perform the position regulation according to the received control instruction from the processor 11 and in turn to lead the position regulation of the driving recorder 1 such that the driving recorder 1 is regulated to the initial status and balanced.

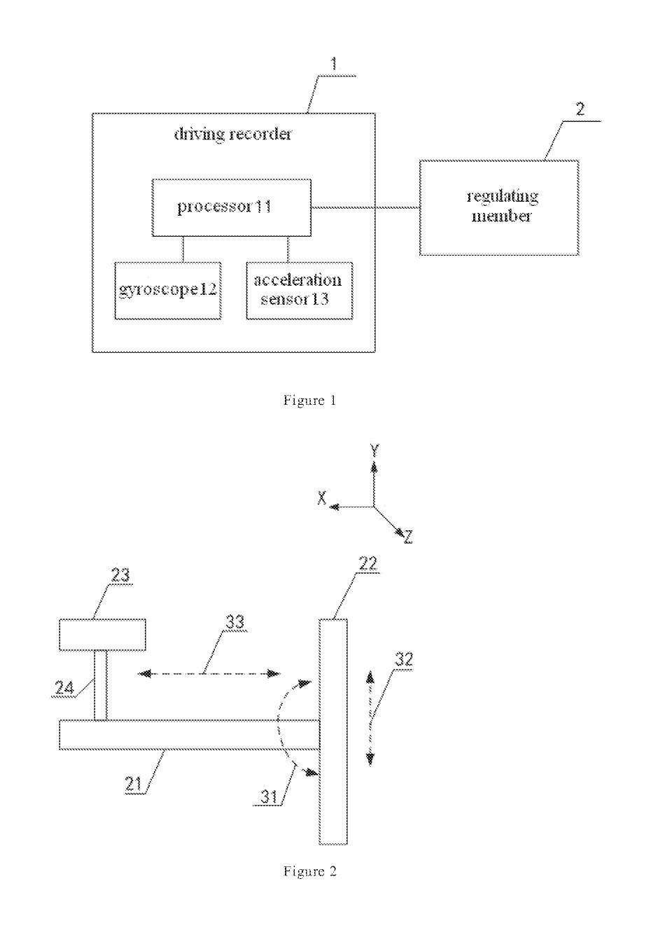

In this embodiment, with reference to FIG. 2, the regulating member 2 is a tri-axial supporting structure including a first shaft 21 (corresponding to X-axis in a three-dimensional coordinate system), a second shaft 22 (corresponding to Y-axis the three-dimensional coordinate system) and a third shaft 23 (corresponding to Z-axis in the three-dimensional coordinate system) which are positioned in three dimensional directions, respectively. The first shaft 21 is a shaft that is arranged in a horizontal direction, perpendicularly connected to the second shaft 22 and movable in a circumferential direction (as shown in dashed line 31) on the basis of the second shaft 22; the second shaft 22 is a shaft that is arranged in a perpendicular direction to the horizontal direction and movable in the perpendicular direction (as shown in dashed line 32); and the third shaft 23 is a shaft that is perpendicularly connected to the first shaft 21 via a connecting member 24 and forward-backward movable with respect to the second shaft 22 (as shown in dashed line 33). The forward-backward movement means a distance variation with respect to the second shaft 22, wherein the forward movement with respect to the second shaft 22 means an approach to the second shaft 22, and the backward movement with respect to the second shaft 22 means a departure from the second shaft 22.

Based on the regulating member 2 with the tri-axial supporting structure, the control instruction from the processor 11 can be received by the first shaft 21, the second shaft 22 and the third shaft 23, respectively, to perform the position regulation.

In the embodied implementation, when each of the first shaft 21, the second shaft 22 and the third shaft 23 is provided with a traction motor (in this embodiment, for example, a brushless DC motor, which is rotatable both in forward and reversal directions and which has a size within 30 mm×20 mm, can be selected), the first shaft 21, the second shaft 22 and the third shaft 23 can receive the control instruction in a form of pulse width modulation signal from the processor 11 through the respective traction motors therein.

For example, the driving recorder can be fixed to the third shaft 23 by screws and fixed to the vehicle via the second shaft 2. When it is desired to move the first shaft 21, the processor 11 can send the correlative control instruction to the first shaft 21, to control the traction motor of the first shaft 21 to move the first shaft 21 on the basis of the second shaft 22 in the circumferential direction such that the driving recorder 1 can be moved with respect to the second shaft 22 in the circumferential direction; when it is desired to move the second shaft 22, the processor 11 can send the correlative control instruction to the second shaft 22, to control the traction motor in the second shaft 22 to move the second shaft 22 with respect to the first shaft 21 in the perpendicular direction such that the driving recorder 1 can be moved with respect to the first shaft 21 in the perpendicular direction; and when it is desired to move the third shaft 23, the processor 11 can send the correlative control instruction to the third shaft 23, to control the traction motor in the third shaft 23 to forward-backward move the third shaft 23 with respect to the second shaft 22 such that the driving recorder 1 can be forward-backward moved with respect to the second shaft 22. The processor can obtain position offset condition of the driving recorder according to the received three-dimensional angular information and three-dimensional acceleration information, and can control the first shaft 21, the second shaft 22 and the third shaft 23 to perform the correlative position regulation according to the position offset condition such that the driving recorder can be regulated to the initial status and balanced in the initial status.

According to the driving recording device in the embodiments of the present disclosure, the driving recording device is provided with the driving recorder and the regulating member; the driving recorder is provided with the processor, the gyroscope and the acceleration sensor; the gyroscope, the acceleration sensor and the regulating member is in communication connection with the processor, respectively; and the driving recorder is connected to the regulating member and connected to the vehicle via the regulating member. Based on this, in the case that the vehicle vibrates or quakes in turn to cause the driving recorder to vibrate or quake, the processor can send the control instructions to the regulating member according to the received three-dimensional angular information from the gyroscope and the received three-dimensional acceleration information from the acceleration sensor, in order to control the regulating member to perform the position regulation and in turn to lead the position regulation of the driving recorder such that the driving recorder can be regulated to the initial status and balanced, ensuring that the driving recorder is always kept in a stabilized status to obtain stable and superior travelling records.

Accordingly, the present invention also provides a regulation and control method using the aforesaid driving recording device.

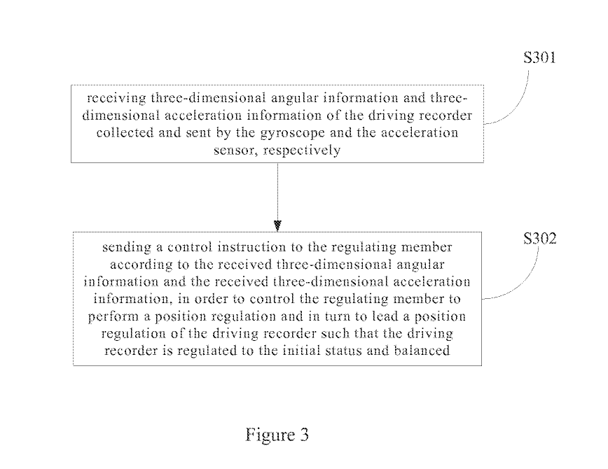

With reference to FIG. 3, it is a schematic flow chart of a regulation and control method using the driving recording device according to an embodiment of the present disclosure. In this embodiment, the driving recording device may include a driving recorder and a regulating member; the driving recorder may include a processor, a gyroscope and an acceleration sensor; the gyroscope and the acceleration sensor can be operated on the basis of a standard three-dimensional coordinate system; the gyroscope, the acceleration sensor and the regulating member are in communication connection with the processor, respectively; the driving recorder is connected to the regulating member; and the driving recorder is connectable to a vehicle through the regulating member.

The method may include steps of:

S301, the processor receiving three-dimensional angular information and three-dimensional acceleration information of the driving recorder collected and sent by the gyroscope and the acceleration sensor, respectively.

That is, the gyroscope is configured to collect the three-dimensional angular information of the driving recorder and send it to the processor, and the acceleration sensor is configured to collect the three-dimensional acceleration information of the driving recorder and send it to the processor.

Herein, the three-dimensional angular information of the driving recorder may include: an angle value by which the driving recorder deviates from X-axis (hereinafter referred to as X-axis angle value), an angle value by which the driving recorder deviates from Y-axis (hereinafter referred to as Y-axis angle value), and an angle value by which the driving recorder deviates from Z-axis (hereinafter referred to as Z-axis angle value).

The three-dimensional acceleration information of the driving recorder may include: an acceleration value of the driving recorder on X-axis (hereinafter referred to as X-axis acceleration value), an acceleration value of the driving recorder on Y-axis (hereinafter referred to as Y-axis acceleration value), and an acceleration value of the driving recorder on Z-axis (hereinafter referred to as Z-axis acceleration value).

After the driving recording device is mounted on the vehicle (that is, after the driving recorder is fixed to the vehicle by the regulating member), the driving recorder may be manually regulated to an appropriate position, and then the gyroscope can capture the correlative three-dimensional angular information of the driving recorder in this status. The three-dimensional angular information in this status is regarded as the three-dimensional angle in the initial status (including an initial X-axis angle value, an initial Y-axis angle value and an initial Z-axis angle value). Regulating the driving recorder to the initial status also means regulating the three-dimensional angle of the driving recorder to the three-dimensional angle in the initial status.

S302, the processor sending a control instruction to the regulating member according to the received three-dimensional angular information and the received three-dimensional acceleration information, in order to control the regulating member to perform a position regulation and in turn to lead a position regulation of the driving recorder such that the driving recorder is regulated to the initial status and balanced.

Since the gyroscope and the acceleration sensor may generate noise data (also known as interference data) in operation, in this embodiment, it is desirable to eliminate the noise data from the collected data to guarantee the accuracy of the collected data.

Based on this, S302 may further include steps of:

Step 1, filtering noise data from the received three-dimensional angular information and the received three-dimensional acceleration information, to obtain valid three-dimensional angular information and valid three-dimensional acceleration information, respectively; and

Step 2, sending an angle regulation instruction to the regulating member according to the valid three-dimensional angular information, such that the regulating member performs a correlative angle regulation according to the angle regulation instruction in order to lead the driving recorder to be regulated to the initial three-dimensional angle, and sending an acceleration regulation instruction to the regulating member according to the valid three-dimensional acceleration information such that the regulating member generates correlative reversal acceleration according to the acceleration regulation instruction in order to lead the driving recorder to generate correlative reversal acceleration.

At Step 1, the noise data is filtered from the received three-dimensional angular information to obtain the valid three-dimensional angular information. In the embodied implementation, a preset interface for filtering the noise data can be invoked to real-time obtain X-axis angle value, Y-axis angle value and Z-axis angle value within a predefined period of time, and respective average values of the obtained X-axis angle values. Y-axis angle values and Z-axis angle values can be calculated.

The preset interface can be a median filter algorithm integrated preset interface, in which a time window (for example, 10 ms as a predefined period of time) can be preset in order to real-time obtain X-axis angle value, Y-axis angle value and Z-axis angle value within 10 ms.

The average value of the obtained X-axis angle values, the average value of the obtained Y-axis angle values and the average value of the obtained Z-axis angle values are calculated, respectively.

Then, differences between the X-axis angle values and the average value of X-axis angle values are calculated to obtain first difference values (containing a plurality of difference values), differences between the Y-axis angle values and the average value of Y-axis angle values are calculated to obtain second difference values (containing a plurality of difference values), and differences between the Z-axis angle values and the average value of Z-axis angle values are calculated to obtain third difference values (containing a plurality of difference values).

Subsequently, the first difference values are compared with a first predefined X-axis angular threshold, respectively, the second difference values are compared with a first predefined Y-axis angular threshold, respectively, and the third difference values are compared with a first predefined Z-axis angular threshold, respectively. On the ground of the comparison result, the noise data can be filtered to obtain valid X-axis angle values, Y-axis angle values and Z-axis angle values.

In the judgment of the noise data, the data having even variation are usually regarded as valid data, while the data having sharp variation are usually regarded as noise data. Therefore, if the comparison result indicates the difference value is not less than the predefined angle threshold, the correlative collected angle value can be judged to be noise data and be removed; if the comparison result indicates the difference value is less than the predefined angle threshold, the correlative collected angle value can be judged to be non-noise data (i.e., valid data and be retained.

At Step 1, the noise data is filtered from the received three-dimensional acceleration information to obtain the valid three-dimensional acceleration information. In the embodied implementation, the aforesaid preset interface for filtering the noise data can be invoked to real-time obtain X-axis acceleration value, Y-axis acceleration value and Z-axis acceleration value within a predefined period of time, and respective average values of the obtained X-axis acceleration values, Y-axis acceleration values and Z-axis acceleration values can be calculated.

For example, it is also possible to real-time obtain X-axis acceleration value, Y-axis acceleration value and Z-axis acceleration value within 10 ms and to calculate the average value of the obtained X-axis acceleration value, the average value of the obtained Y-axis acceleration values and the average value of the obtained Z-axis acceleration values, respectively.

Then, differences between the X-axis acceleration values and the average value of X-axis acceleration values are calculated to obtain fourth difference values (containing a plurality of difference value), differences between the Y-axis acceleration values and the average value of Y-axis acceleration values are calculated to obtain fifth difference values (containing a plurality of difference value), and differences between the Z-axis acceleration values and the average value of Z-axis acceleration values are calculated to obtain sixth difference values (containing a plurality of difference value).

Subsequently, the fourth difference values are compared with a first predefined X-axis acceleration threshold, respectively, the fifth difference values are compared with a first predefined Y-axis acceleration threshold, respectively, and the sixth difference values are compared with a first predefined Z-axis acceleration threshold, respectively. On the ground of the comparison result, the noise data can be filtered to obtain the valid X-axis acceleration values, Y-axis acceleration values and Z-axis acceleration values.

In the judgment of the noise data, the data having even variation are usually regarded as valid data, while the data having sharp variation are usually regarded as noise data. Therefore, if the comparison result indicates the difference value is not less than the predefined acceleration, the correlative collected acceleration value can be judged to be noise data and be removed; if the comparison result indicates the difference value is less than the predefined acceleration, the correlative collected acceleration value can be judged to be non-noise data (i.e., valid data) and be retained.

Further, at Step 2, the angle regulation instruction is sent to the regulating member according to the valid three-dimensional angular information, such that the regulating member performs the correlative angle regulation according to the angle regulation instruction in order to lead the driving recorder to be regulated to the initial three-dimensional angle. In the embodied implementation, it is possible to first calculate an absolute value of a difference between the average value of X-axis angle values and an initial X-axis angle value to obtain a first absolute value, an absolute value of a difference between the average value of Y-axis angle values and an initial Y-axis value to obtain and absolute value, and an absolute value of a difference between the average value of Z-axis angle values and an initial Z-axis angle value to obtain a third absolute value, respectively.

Then, the first absolute value is compared with a second predefined X-axis angular threshold, the second absolute value is compared with a second predefined Y-axis angular threshold, and the third absolute value is compared with a second predefined Z-axis angular threshold. On the ground of the comparison result, the angle regulation instruction may be sent to the regulating member such that the regulating member performs the correlative angle regulation according to the angle regulation instruction in order to lead the driving recorder to be regulated to the initial three-dimensional angle.

If the absolute values are not less than the predefined angle thresholds, instructions for regulating angles corresponding to the absolute values may be sent to the regulating member, such that the regulating member can perform the correlative angle regulation according to the instruction m order to lead the driving recorder to be regulated to the initial three-dimensional angle.

Taking the regulating member with above structure as shown in FIG. 2 as an example, if the first absolute value is not less than the second predefined X-axis angular threshold, an instruction for regulating an angle corresponding to the first absolute value may be sent to the first shaft (for example, if the first absolute value is 3°, an instruction for regulating 3° may be sent to the first shaft), such that the first shaft performs a correlative angular regulation; if the second absolute value is not less than the second predefined Y-axis angular threshold, an instruction for regulating an angle corresponding to the second absolute value may be sent to the second shaft, such that the second shaft performs a correlative angular regulation; and if the third absolute value is not less than the second predefined Z-axis angular threshold, an instruction for regulating an angle corresponding to the third absolute value may be sent to the third shaft, such that the third shaft performs a correlative angular regulation, in order to lead the driving recorder to be regulated to the initial three-dimensional angle.

At Step 2, the acceleration regulation instruction is sent to the regulating member according to the valid three-dimensional acceleration information such that the regulating member generates the correlative reversal acceleration according to the acceleration regulation instruction, in the embodied implementation, it is possible to first compare the average value of X-axis acceleration values, the average value of Y-axis acceleration values and the average value of Z-axis acceleration values with the second predefined X-axis acceleration threshold, the second predefined Y-axis acceleration threshold and the second predefined Z-axis acceleration threshold, respectively. Then on the ground of the comparison result, the acceleration regulation instruction may be sent to the regulating member such that the regulating member generates the correlative reversal acceleration according to the acceleration regulation instruction.

If the average values are not less than the predefined acceleration thresholds, instructions for generating equal reversal acceleration may be sent to the regulating member. The reversal acceleration has a magnitude of respective average value and a direction opposite to the direction of current acceleration, such that the regulating member can perform the correlative acceleration regulation according to the instruction in order to lead the driving recorder to be regulated to the initial three-dimensional acceleration, to counteract the acceleration caused by the vibration or quake of the vehicle.

Taking the regulating member with above structure as shown in FIG. 2 as an example, if the average value of X-axis acceleration is not less than the second predefined X-axis acceleration threshold, an acceleration regulation instruction containing a magnitude of the average value of X-axis acceleration and a direction opposite to the direction of current acceleration may be sent to the first shaft, such that the first shaft can apply correlative reversal acceleration to the driving recorder according to the instruction; if the average value of Y-axis acceleration is not less than the second predefined Y-axis acceleration threshold, an acceleration regulation instruction containing a magnitude of the average value of Y-axis acceleration and a direction opposite to the direction of current acceleration may be sent to the second shaft, such that the second shaft can apply correlative reversal acceleration to the driving recorder according to the instruction; and if the average value of Z-axis acceleration is not less than the second predefined Z-axis acceleration threshold, an acceleration regulation instruction containing a magnitude of the average value of Z-axis acceleration and a direction opposite to the direction of current acceleration may be sent to the third shaft, such that the third shaft can apply correlative reversal acceleration to the driving recorder according to the instruction. The regulation of acceleration can be made in three dimensional directions, ensuring that the driving recorder is balanced.

In the embodiments of the present disclosure, the predefined acceleration thresholds (including the first predefined X-axis acceleration threshold, the first predefined Y-axis acceleration threshold, the first predefined Z-axis acceleration threshold, the second predefined X-axis acceleration threshold, the second predefined Y-axis acceleration threshold and the second predefined Z-axis acceleration threshold) and the predefined angle thresholds (including the first predefined X-axis angular threshold, the first predefined Y-axis angular threshold, the first predefined Z-axis angular threshold, the second predefined X-axis angular threshold, the second predefined Y-axis angular threshold and the second predefined Z-axis angular threshold) can be set depending on experience and practice.

According to the regulation and control method using the driving recording device in the embodiments of the present disclosure, the driving recording device is provided with the driving recorder and the regulating member; the driving recorder is provided with the processor, the gyroscope and the acceleration sensor; the gyroscope, the acceleration sensor and the regulating member is in communication connection with the processor, respectively; and the driving recorder is connected to the regulating member and connected to the vehicle via the regulating member. Based on this, in the case that the vehicle vibrates or quakes in turn to cause the driving recorder to vibrate or quake, the processor can send the control instructions to the regulating member according to the received three-dimensional angular information from the gyroscope and the received three-dimensional acceleration information from the acceleration sensor, in order to control the regulating member to perform the position regulation and in turn to lead the position regulation of the driving recorder such that the driving recorder can be regulated to the initial status and balanced, ensuring that the driving recorder is always kept in a stabilized status to obtain stable and superior travelling records.

The device embodiment is described above merely for a schematic purpose, wherein the units explained as individual members may or may not be physically separated, the members shown as units may or may not be physical units and they can be located in a place or also can be distributed to network units. As necessary in practice, some or all of the modules can be selected to complete the objectives of the schemes of the embodiments. An ordinary person skilled in the art may understand and implement the embodiments without contributing creative labor.

Through above description of the implementations, it is obvious for the skilled in the art that the implementations can be completed by means of software in connection with necessary universal hardware platform or of course by means of hardware. Based on this understanding, the essence of aforesaid technical schemes or the part contributing to the prior art can be embodied in a form of software product. The computer software product can be stored in computer readable storage medium such as ROM/RAM, magnetic disc, compact disc and the like, which contains a plurality of instructions such that a computing device (such as, personal compute server or network apparatus) is able to execute the methods as described in the embodiments or a portion of the embodiment.

In the end, it should be explained that aforesaid embodiments are provided for the illustrative not limiting purpose of the technical schemes of the present disclosure. Although the present invention has been described in detail with reference to the embodiments, it should be understood that modifications or equivalent substitutions can be made to the technical schemes or some of technical features therein as disclosed the embodiments by those skilled in the art; the modifications or substitutions will not bring the essence of the respective technical schemes to depart from spirit and scope of the technical schemes of the inventive embodiments.

1. A driving recording device, comprising a driving recorder provided with a processor, wherein the driving recorder further comprises:
a gyroscope, configured to collect three-dimensional angular information of the driving recorder and send the collected three-dimensional angular information to the processor; and
an acceleration sensor, configured to collect three-dimensional acceleration information of the driving recorder and send the collected three-dimensional acceleration information to the processor;
the driving recording device further comprises:
a regulating member, configured to perform a position regulation according to a received control instruction from the processor and to lead a position regulation of the driving recorder such that the driving recorder is regulated to an initial status and balanced;
the processor is configured to send the control instruction to the regulating member according to the received three-dimensional angular information from the gyroscope and the received three-dimensional acceleration information from the acceleration sensor, in order to control the regulating member to perform the position regulation and to lead the position regulation of the driving recorder such that the driving recorder is regulated to the initial status and balanced;
wherein, the gyroscope, the acceleration sensor and the regulating member are in communication connection with the processor, respectively, and the driving recorder is connected to the regulating member and connected to a vehicle via the regulating member.

2. The driving recording device according to claim 1, wherein the regulating member is a tri-axial supporting structure comprises a first shaft, a second shaft and a third shaft which are positioned in three dimensional directions, respectively; the first shaft is a shaft that is arranged in a horizontal direction, perpendicularly connected to the second shaft and movable in a circumferential direction and movable in a circumferential direction on the basis of the second shaft, the second shaft is a shaft that is arranged in a perpendicular direction to the horizontal direction and movable in the perpendicular direction with respect to the first shaft, and the third shaft is a shaft that is perpendicularly connected to the first shaft via a connecting member and forward-backward movable with respect to the second shaft,
wherein, the regulating member receives the control instruction from the processor by the first axis, the second shaft and the third shaft to perform the position regulation.

3. The driving recording device according to claim 2, wherein each of the first shaft, the second shaft and the third shaft is provided with a fraction motor,
wherein the first axis, the second shaft and the third shaft receive the control instruction in a form of pulse width modulation signal from the processor the respective traction motors therein.

4. The driving recording device according to claim 3, wherein the traction motor is a brushless DC motor rotatable both in forward and reversal directions.

5. The driving recording device according to claim 1-4, wherein the gyroscope is a MPU-6050 model gyroscope, and the acceleration sensor is a MMA8452QR1 model acceleration sensor.

6. A regulation and control method using a driving recording device, the driving recording device comprising a driving recorder provided with a processor, wherein the driving recorder further comprises a gyroscope and an acceleration sensor, the driving recording device further comprises a regulating member, the gyroscope, the acceleration sensor and the regulating member are in communication connection with the processor, respectively, and the driving recorder is connected to the regulating member and connected to a vehicle via the regulating member;
the method comprises:
the processor receiving three-dimensional angular information and three-dimensional acceleration information of the driving recorder collected and sent by the gyroscope and the acceleration sensor, respectively; and
the processor sending a control instruction to the regulating member according to the received three-dimensional angular information and the received three-dimensional acceleration information, in order to control the regulating member to perform a position regulation and to lead a position regulation of the driving recorder such that the driving recorder is regulated to the initial status and balanced.

7. The method according to claim 6, wherein the step of sending a control instruction to the regulating member according to the received three-dimensional angular information and the received three-dimensional acceleration information, in order to control the regulating member to perform a position regulation and to lead a position regulation of the driving recorder, comprises:
filtering noise data from the received three-dimensional angular information and the received three-dimensional acceleration information, to obtain valid three-dimensional angular information and valid three-dimensional acceleration information, respectively; and
sending an angle regulation instruction to the regulating member according to the valid three-dimensional angular information, such that the regulating member performs a correlative angle regulation according to the angle regulation instruction in order to lead the driving recorder to be regulated to the initial three-dimensional angle, and sending an acceleration regulation instruction to the regulating member according to the valid three-dimensional acceleration information such that the regulating member applies correlative reversal acceleration to the driving recorder according to the acceleration regulation instruction.

8. The method according to claim 7, wherein the three-dimensional angular information contains X-axis angle value, Y-axis angle value and Z-axis angle value;
the step of filtering noise data from the received three-dimensional angular information to obtain valid three-dimensional angular information, comprises:
invoking a preset interface for filtering the noise data to real-time obtain X-axis angle value, Y-axis angle value and Z-axis angle value within a predefined period of time, and calculating respective average values of the obtained X-axis angle values, Y-axis angle values and Z-axis angle values;
calculating differences between the X-axis angle values and the average value of X-axis angle values, differences between the Y-axis angle values and the average value of Y-axis angle values and differences between the Z-axis angle values and the average value of Z-axis angle values, to obtain first difference values, second difference values and third difference values; and
comparing the first difference values, second difference values and third difference values with a first predefined X-axis angular threshold, a first predefined Y-axis angular threshold and a first predefined Z-axis angular threshold, respectively, and on the ground of the comparison result, filtering the noise data to obtain valid X-axis angle values, Y-axis angle values and Z-axis angle values.

9. The method according to claim 7, wherein the three-dimensional acceleration information contains X-axis acceleration value, Y-axis acceleration value, Z-axis acceleration value;
the step of filtering the noise data from the three-dimensional acceleration information to obtain the valid three-dimensional acceleration information, comprises:
invoking the preset interface for filtering the noise data to real-time obtain X-axis acceleration value, Y-axis acceleration value, Z-axis acceleration value within a predefined period of time, and calculating respective average values of the obtained X-axis acceleration values, Y-axis acceleration values and Z-axis acceleration values;
calculating differences between the X-axis acceleration values and the average value of X-axis acceleration values, differences between the Y-axis acceleration values and the average value of Y-axis acceleration values and differences between the Z-axis acceleration values and the average value of Z-axis acceleration values, to obtain fourth difference values, fifth difference values, sixth difference values; and
comparing the fourth difference values, the fifth difference value and the sixth difference values with a first predefined X-axis acceleration threshold, a first predefined Y-axis acceleration threshold and a first predefined Z-axis acceleration threshold, respectively, and on the ground of the comparison result, filtering the noise data to obtain the valid X-axis acceleration values, Y-axis acceleration values, Z-axis acceleration values.

10. The method according to claim 9, wherein it further comprises: receiving the three-dimensional angular information of the driving recorder collected and sent by the gyroscope, which contains initial X-axis angle value, initial Y-axis angle value, initial Z-axis angle value of the driving recorder in the initial status;
the step of sending an angle regulation instruction to the regulating member according to the valid three-dimensional angular information, such that the regulating member performs a correlative angle regulation according to the angle regulation instruction in order to lead the driving recorder to be regulated to the initial three-dimensional angle, comprises:
calculating an absolute value of a difference between the average value of X-axis angle values and the initial X-axis angle value, an absolute value of a difference between the average value of Y-axis angle values and the initial Y-axis angle value and an absolute value of a difference between the average value of Z-axis angle values and the initial Z-axis angle value, to obtain a first absolute value, a second absolute value and a third absolute value, respectively; and
comparing the first absolute value, the second absolute value and the third absolute value with a second predefined X-axis angular threshold, a second predefined Y-axis angular threshold and a second predefined Z-axis angular threshold, respectively, and on the ground of the comparison result, sending the angle regulation instruction to the regulating member such that the regulating member performs the correlative angle regulation according to the angle regulation instruction in order to lead the driving recorder to be regulated to the initial three-dimensional angle.

11. The method according to claim 10, wherein the step of sending an acceleration regulation instruction to the regulating member according to the valid three-dimensional acceleration information such that the regulating member applies correlative reversal acceleration to the driving recorder according to the acceleration regulation instruction, comprises:
comparing the average value of X-axis acceleration value, the average value of Y-axis acceleration value and the average value of Z-axis acceleration value with a second predefined X-axis acceleration threshold, a second predefined Y-axis acceleration threshold and a second predefined Z-axis acceleration threshold, respectively, and on the ground of the comparison result, sending the acceleration regulation instruction to regulating member such that the regulating member generates the correlative reversal acceleration according to the acceleration regulation instruction.

12. The driving recording device according to claim 2, wherein the gyroscope is a MPU-6050 model gyroscope, and the acceleration sensor is a MMA8452QR1 model acceleration sensor.

13. The driving recording device according to claim 3, wherein the gyroscope is a MPU-6050 model gyroscope, and the acceleration sensor is a MMA8452QR1 model acceleration sensor.

14. The driving recording device according to claim 4, wherein the gyroscope is a MPU-6050 model gyroscope, and the acceleration sensor is a MMA8452QR1 model acceleration sensor.

15. The method according to claim 11, wherein the three-dimensional acceleration information contains X-axis acceleration value, Y-axis acceleration value, Z-axis acceleration value;
the step of filtering the noise data from the three-dimensional acceleration information to obtain the valid three-dimensional acceleration information, comprises:
invoking the preset interface for filtering the noise data to real-time obtain X-axis acceleration value, Y-axis acceleration value, Z-axis acceleration value within a predefined period of time, and calculating respective average values of the obtained X-axis acceleration values, Y-axis acceleration values and Z-axis acceleration values;
calculating differences between the X-axis acceleration values and the average value of X-axis acceleration values, differences between the Y-axis acceleration values and the average value of Y-axis acceleration values and differences between the Z-axis acceleration values and the average value of Z-axis acceleration values, to obtain fourth difference values, fifth difference values, sixth difference values; and
comparing the fourth difference values, the fifth difference value and the sixth difference values with a first predefined X-axis acceleration threshold, a first predefined Y-axis acceleration threshold and a first predefined Z-axis acceleration threshold, respectively, and on the ground of the comparison result, filtering the noise data to obtain the valid X-axis acceleration values, Y-axis acceleration values, Z-axis acceleration values.
